(19) United States
(12) Patent Application Publication
(10) Pub. No.: US 2009/0091943 A1
(43) Pub. Date: Apr. 9, 2009

(54) Ambient Lighting Display

(75) Inventor: James Hotary, Holland, MI (US)

Correspondence Address: GIBSON & DERNIER L.L.P., 900 ROUTE 9 NORTH, SUITE 504, WOODBRIDGE, NJ, 07095, US

(73) Assignee: FAURECIA INTERIOR SYSTEMS U.S.A., INC., Auburn Hills, MI (US)

(21) Appl. No.: 11/868,192

(22) Filed: Oct. 5, 2007

(51) Int. Cl. B60Q 1/00

(52) U.S. Cl. 362/488

(57) ABSTRACT

An ambient lighting display is obtained directly on a portion of an interior panel. The portion of the panel is covered with a paint or ink which reacts to ultraviolet light by emitting visible light of a predetermined color. To obtain a lighting display, a portion of the panel is illuminated with ultraviolet light of an appropriate wavelength to cause the paint or ink to fluoresce with the predetermined color.

### BACKGROUND OF THE INVENTION

The present invention relates generally to interior displays and, more particularly, concerns ambient lighting displays useful in the interior of an automotive vehicle.

As used herein, the term “ambient lighting display” will be understood to be a display that has the appearance of being provided by ambient lighting in an interior location, rather than by an artificial source, such as a lamp, an illuminated display, or the like.

The use of interior information displays of all types is widespread in modern life. In modern automotive vehicles, in particular, one is presented with an array of interior information displays on the dashboard, and all over the vehicle. Typically, displays are provided by illuminated electrical or electronic devices which are embedded in a panel. In combination such displays tend to be brash and, often, distracting to the driver.

It would be desirable to provide such displays in a manner that they appear to be part of the vehicle interior or directly on an interior panel. However, the panels inside vehicles tend to be black or some other dark color, and they are usually textured, so they do not provide adequate reflection of the visible light for such a display.

It is an object of the present invention to provide an interior lighting display that has the appearance of being provided by ambient light, offering a subdued, elegant appearance. It is also contemplated that the display be appropriate for use in the interior of an automotive vehicle and that it be capable of providing information to the driver and passengers.

### SUMMARY OF THE INVENTION

In accordance with one aspect of the present invention, an ambient lighting display is obtained directly on a portion of an interior panel. The portion of the panel is covered with a paint or ink which reacts to ultraviolet light by emitting visible light of a predetermined color. To obtain a lighting display, a portion of the panel is illuminated with ultraviolet light of an appropriate wavelength to cause the paint or ink to fluoresce with the predetermined color.

Preferably, the portion of the panel is opaque and contains a plurality of different, superimposed layers that fluoresce with different colors and respond to different wavelengths of light. Information may then be displayed via color, by illuminating the portion with the appropriate wavelength of light. Although the illuminating light is not visible, the fluorescing display is, providing an ambient lighting display.

In accordance with another aspect of the invention, the portion of the display panel may be transparent or translucent, with the paint or ink on the interior of the panel, and with the fluorescing light shining through from the interior (behind the panel).

### BRIEF DESCRIPTION OF THE DRAWINGS

The foregoing brief description, as well as further objects, features, and advantages of the present invention will be understood more completely from the following detailed description of a presently preferred, but nonetheless illustrative, embodiments with reference being had to the accompanying drawings, in which:

FIG. 1 is an interior view of an automobile showing a driver and passenger from the rear and a dashboard D embodying the present invention;

FIGS. 2 and 3 are enlarged front views of the vents 10 and 12, respectively in the system of FIG. 1;

FIG. 4 is a schematic diagram illustrating an operating principle of the invention; and

FIG. 5 is a schematic representation of a preferred embodiment of the invention, in the form of an climate control vent unit.

### DETAILED DESCRIPTION OF THE PREFERRED EMBODIMENTS

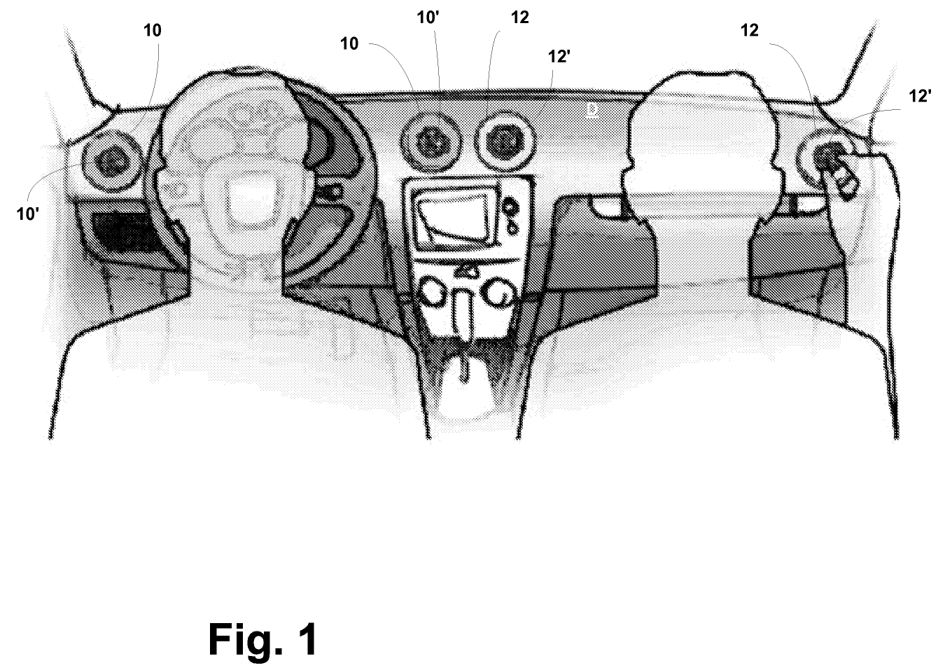

Turning now to the drawings, FIG. 1 is an interior view of an automobile showing a driver and passenger from the rear and a dashboard D embodying the present invention. Dashboard D has a pair of driver-side climate control vent units 10, 10 and a pair of passenger-side air-conditioning vent units 12, 12 made, for example, of a black plastic material. Driver-side climate control vents 10, 10 each have an environmental ring-shaped display 10′ which is currently illuminated in red, and passenger-side climate control vents 12, 12 each have an environmental ring-shaped display 12′ which is currently illuminated in blue.

The colors of the rings reflect their respective setting of the air-conditioning system. For example, here the driver has set his portion of the system to increase the temperature, and a passenger has said this portion of the system to decrease the temperature. The passenger is shown adjusting the air-conditioning system by operating a control (not shown) at the center of the vent unit. When the system is set to maintain the current temperature, the vents are not illuminated.

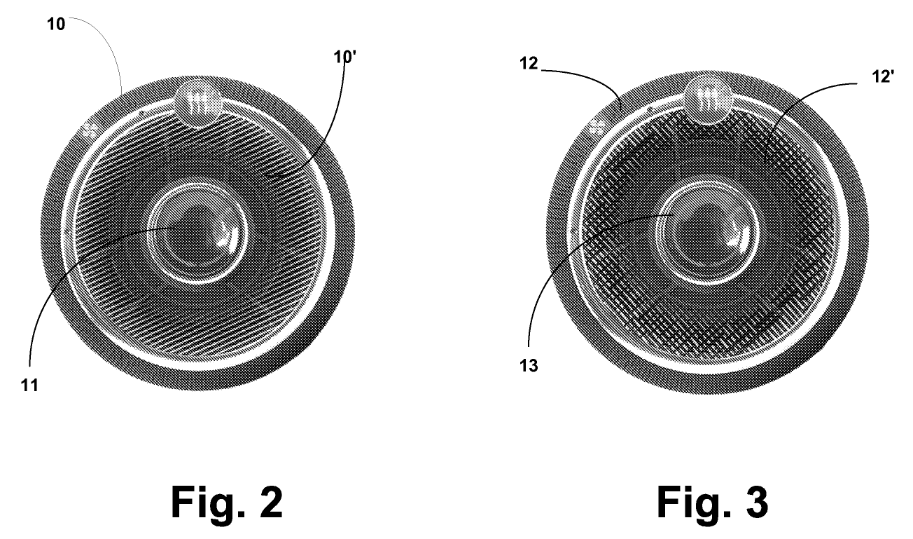

FIGS. 2 and 3 are enlarged front views of the vents 10 and 12, respectively. As may be seen, vents 10, 12 have central controllers 11, 13, which may be rotated clockwise or counterclockwise to increase and decrease temperature, respectively. Vent 10 displays a ring-shaped section 10′ that is hatched to represent red, because it is adjusted to increase temperature, whereas vent 12 displays ring-shaped section 12′ that is hatched to represent blue, because it has been adjusted to decrease temperature. When a vent is adjusted so that temperature does not change, it is not illuminated and retains its natural, black color.

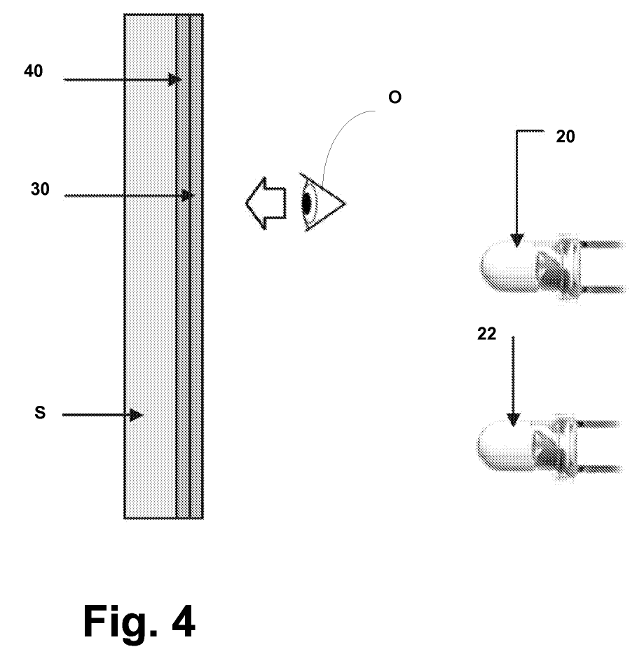

FIG. 4 is a schematic diagram illustrating a principle of the invention. An ambient lighting display is to be created on the surface of a substrate S. A layer 30 of transparent ink or paint is provided on the surface of the substrate S, and the ink or paint is formulated to fluoresce with a predetermined color, for example red, when subjected to ultraviolet light of a predetermined wavelength. A source of ultraviolet light of the predetermined wavelength, such as a photodiode 20, may be actuated, and it will cause the layer 30 to produce a red glow, which can be observed by an Observer O.

When the substrate and the photodiode are arranged as illustrated in FIG. 4, the substrate is a preferably opaque. However, it is also possible for the substrate to be transparent or translucent, in which event the Observer would be on the opposite side of the substrate to that shown in FIG. 4 and looking towards the photodiode 20. This form of rear projection display could be useful

In accordance with another aspect of the invention, substrate S can be provided with two superimposed coatings 30, 40 which fluoresce in different colors in response to different wavelengths of ultraviolet light. For example, layer 30 might fluoresce red in response to ultraviolet light of a wavelength of 365 nm, while layer 30 might fluoresce blue in response to ultraviolet light with a wavelength of 400 nm. Ultraviolet light emitters 20, 22 would then be provided which emit ultraviolet light at wavelengths of 365 nm and 400 nm, respectively. By selectively actuating emitters 20, 22, it is possible to selectively cause substrate S to emit a red or blue glow.

Preferably, layer 30 is an ink known as Superimaging “Red” and layer 40 is an ink known as Superimaging “Blue”, both being available from Superimaging, Inc. of Fremont, Calif. Emitter 20 is preferable a model NSSU1100AT, an LED available from Nichia Corporation, and emitter 22 is preferable a model LED5-UV-405-30, and LED available from Bivar, Inc.

Those skilled in the art will appreciate that it is possible to produce illumination in additional colors by providing additional superimposed layers over the layers 30, 40, as well as a corresponding ultraviolet light emitter for each layer. For example, it might be desirable to add a third layer that glows green. By selecting the amount of illumination provided for each layer, it would then be possible to generate any color using an appropriate RGB combination. In this manner, the entire visible light spectrum can be displayed, making it possible to display a continuum of values. It would also make it possible to provide a mood lighting effect or to vary color in relationship to music.

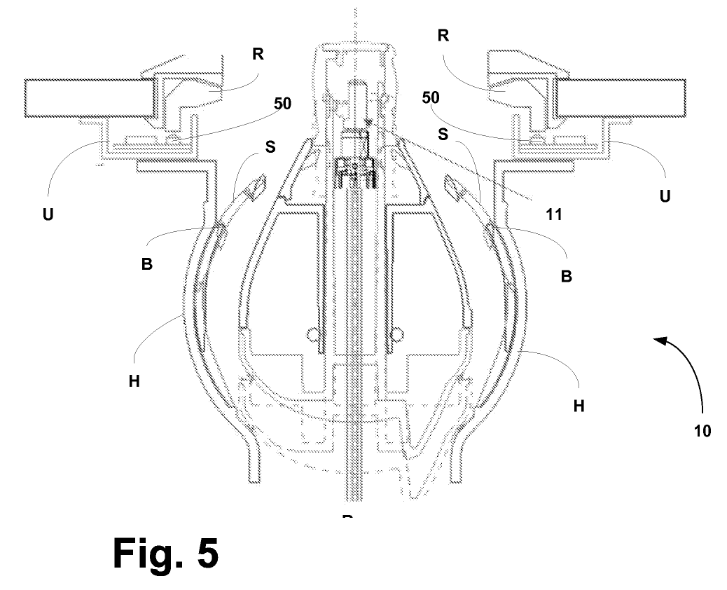

In accordance with a preferred embodiment of the invention, the foregoing principles are utilized to provide climate control vent units 10 and 12 as described above. FIG. 5 is a schematic representation of such a unit 10. The unit is mounted behind a panel P, such as the dashboard D described above. Unit 10 has a rotatable controller 11 mounted within a body B, which is in turn mounted in a housing H connected to the panel P. At the top of housing H, there are provided a plurality of ultraviolet light emitting units U in a generally circular arrangement, as seen looking down in FIG. 5. Above the units U, and aligned with light emitters 50, there is provided a prismatic ring R, which bends light emitted from emitters 50 so as to direct it at an opaque surface S of body B. Ring R will therefore illuminate surface S with ultraviolet light when he emitters 50 are actuated.

Those skilled in the art will appreciate that surface S can be provided with a plurality of superimposed layers that fluoresce with different colors in response to ultraviolet light of different wavelengths. Unit U would then include selectively actuable light emitters corresponding to each layer, and it would be possible to cause surface S to glow with a plurality of different colors.

The vent unit 10 described above will glow in different colors or will remain dark. Those skilled in the art will appreciate that light emitting units may be controlled to produce illumination at different angular orientations and/or with different angular lengths, permitting a quantitative indication of the temperature setting.

In the preferred embodiments coatings have been used which are responsive to ultraviolet radiation and fluoresce in a visible color. However, it will be appreciated that the excitation of spectrum of the coatings is not a critical limitation. It is only important that the coatings emit visible light and be capable of excitation with light that is not visible.

Although preferred embodiments of the invention have been disclosed for illustrative purposes, those skilled in the art will appreciate that many additions, modifications and substitutions are possible without departing from the scope and spirit of the invention as defined by the accompanying claims.

What is claimed:

1. An ambient lighting display formed on a section of an interior panel, comprising a coating on a viewable portion of said panel which reacts to invisible light of a predetermined wavelength by emitting visible light of a predetermined color and a source of invisible light at the predetermined wavelength constructed to selectively illuminate said coating.

2. The ambient lighting display of claim 1, wherein the invisible light is in the ultraviolet spectrum.

3. The ambient lighting display of claim 2, wherein the coating emits red light in response to ultraviolet light having a wavelength of approximately 365 nm.

4. The ambient lighting display of claim 2, wherein the coating emits blue light in response to ultraviolet light having a wavelength of approximately 400 nm.

5. The ambient lighting display of claim 1 wherein the coating is one of transparent and translucent.

6. The ambient lighting display of claim 1, wherein at least part of said portion is opaque, said source impinging on a surface of the portion that is to be viewed.

7. The ambient lighting display of claim 1, wherein at least part of said portion is one of transparent and translucent, said source impinging behind a surface of the part which is to be viewed.

8. The ambient lighting display of claim 1, further comprising a second coating on the portion of said panel which reacts to invisible light of a predetermined wavelength by emitting visible light of a second predetermined color and a second source of invisible light at the second predetermined wavelength constructed to selectively illuminate said second coating.

9. The ambient lighting display of claim 8, wherein the invisible light corresponding to one of said coatings is in the ultraviolet spectrum.

10. The ambient lighting display of claim 8, wherein one of said coatings emits red light in response to ultraviolet light having a wavelength of approximately 365 nm.

11. The ambient lighting display of claim 8, wherein one of said coatings emits blue light in response to ultraviolet light having a wavelength of approximately 400 nm.

12. The ambient lighting display of claim 8 wherein one of said coatings is one of transparent and translucent.

13. The ambient lighting display of claim 8 wherein said coatings are at least overlapped.

14. The ambient lighting display of claim 8, wherein at least part of said portion is opaque, said sources impinging on a surface of the portion that is to be viewed.

15. The ambient lighting display of claim 8, wherein at least part of said portion is one of transparent and translucent, said sources impinging behind a surface of the part which is to be viewed.

16. The ambient lighting display of claim 8 further comprising a third coating on the portion of said panel which reacts to invisible light of a predetermined wavelength by emitting visible light of a third predetermined color and a third source of invisible light at the third predetermined wavelength constructed to selectively illuminate said third coating, the coatings emitting light at three primary colors, whereby the sources of invisible light may be controlled so that the coatings cooperatively produce light of any selected color.

17. The ambient lighting display of claim 8 wherein the viewable portion is associated with an operating system in a vehicle and further comprising a controller for the sources which is linked to the system and constructed to control the sources so that the colors emitted by the coatings are indicative of an adjustment of the system.

18. The ambient lighting display of claim 17 wherein the system is the climate control system of a vehicle and the viewable portion is on a vent unit in the vehicle, the emitted light corresponding to a temperature setting of the climate control system.

19. The ambient lighting display of claim 18 wherein there is a user operable temperature setting control in proximity to the viewable portion, whereby a viewer receives a visible indication of a temperature setting he has made.

20. The ambient lighting display of claim 1 wherein the viewable portion is associated with an operating system in a vehicle and further comprising a controller for the source which is linked to the system and constructed to control the source so that the color emitted by the coating is indicative of an adjustment of the system.

21. The ambient lighting display of claim 20 wherein the system is the climate control system of a vehicle and the viewable portion is on a vent unit in the vehicle, the emitted light corresponding to a setting of the climate control system.

22. The ambient lighting display of claim 21 wherein there is a user operable temperature setting control in proximity to the viewable portion, whereby a viewer receives a visible indication of a setting he has made.
